(19) United States
(12) Patent Application Publication
(10) Pub. No.: US 2010/0325140 A1
(43) Pub. Date: Dec. 23, 2010

(54) SYSTEM FOR AND METHOD OF PARALLEL SEARCHING

(75) Inventors: Paul V. HUBNER, McKinney, TX (US); Kristopher A. PATE, Sachse, TX (US); Steven T. ARCHER, Dallas, TX (US); Robert A. CLAVENNA, Lucas, TX (US)

Correspondence Address: VERIZON;PATENT MANAGEMENT GROUP, 1320 North Court House Road, 9th Floor, ARLINGTON, VA, 22201-2909, US

(73) Assignee: Verizon Patent and Licensing Inc., Basking Ridge, NJ (US)

(21) Appl. No.: 12/487,132

(22) Filed: Jun. 18, 2009

(51) Int. Cl. G06F 17/30

(52) U.S. Cl. 707/769; 707/759; 707/708

(57) ABSTRACT

A system for and method of parallel searching is presented. According to an embodiment, the techniques may be realized as a method, comprising receiving, at a network device, an indication of an electronic media selection from a user, identifying a search input in metadata associated with the electronic media selection, searching one or more electronic data sources based at least in part on the identified search input, and providing one or more search results via a network to one or more devices accessible to the user, wherein the one or more search results are capable of being delivered during delivery of the electronic media selection to the user.

### BACKGROUND INFORMATION

Many forms of media, such as television, provide limited interaction with a user. Users who may want additional information have to collect the information through their own efforts. The ability of a user to learn and explore a topic is limited to the fixed presentation of the topic in the media or the user's own efforts to find an alternative source of information.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a system for parallel searching according to a particular embodiment;

FIG. 2 is a block diagram of a hardware component of a system for parallel searching according to a particular embodiment; and

FIG. 3 is a flowchart illustrating functionality for parallel searching of a particular embodiment.

### DETAILED DESCRIPTION OF PREFERRED EMBODIMENTS

A user of media, such as television programming, streaming media, or other non-interactive programming may desire more information, contacts, products, or services associated with the media. According to one or more embodiments, a user device, such as a set-top box, may detect a user media selection, such as a programming or channel selection. One or more components or processes may access metadata associated with the media selection and may identify search criteria based at least in part on the metadata. For example, metadata may include closed captioning information, electronic program guide information, a digital TV sub-channel, and a programming metadata database One or more components or processes may search an electronic data source based at least in part on the search criteria to retrieve additional information. The search results may be further processed such as, for example, filtered or formatted. Formatting may include putting the search results into a format compatible with one or more user devices. For example, search results may be formatted as eXtensible Markup Language (“XML”) and provided to a user as a Really Simple Syndication (“RSS”) feed which may be sent as a text message to a user. Search results may include, for example, one or more of: product information associated with an electronic media selection, service information associated with an electronic media selection, a website associated with an electronic media selection, an online reference associated with an electronic media selection, and contact information associated with an electronic media selection. The searches may be performed at the time media is being viewed or listened to by a user. Responses may also be presented to one or more user devices while a user is viewing or listening to their selected media.

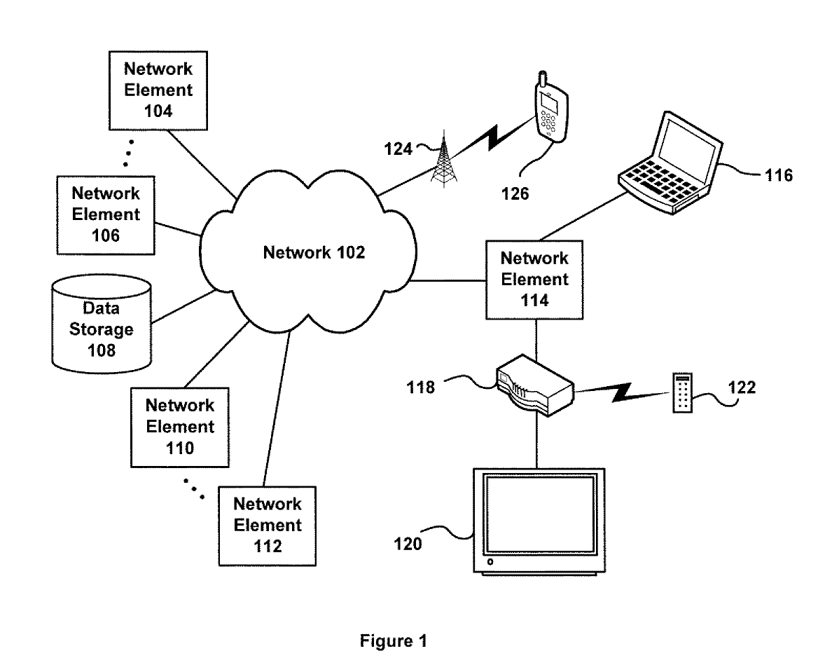

FIG. 1 is a schematic diagram illustrating a system for parallel searching according to particular embodiments. As illustrated, network 102 may be communicatively coupled with one or more devices including network element 104, network element 106, data storage 108, network element 110, network element 112, and network element 114. Other devices may be communicatively coupled with network 102 via one or more intermediary devices, such as transmitter/receiver 124 and network element 114. Wireless device 126 may be communicatively coupled with network 102 via transmitter/receiver 124. Network client 116 and set-top box 118 may be communicatively coupled with network 102 via network element 114. Wireless control 122 may be communicatively coupled with set-top box 118 via infrared, Bluetooth communication, or other wireless technologies. Television set 120 may be communicatively coupled to set-top box 118.

Network 102 may be a wireless network, a wired network or any combination of wireless network and wired network. For example, network 102 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.l, 802.11n and 802.11g or any other wired or wireless network for transmitting and/or receiving a data signal. In addition, network 102 may include, without limitation, telephone line, fiber optics, IEEE Ethernet 802.3, a wide area network (“WAN”), a local area network (“LAN”), or a global network such as the Internet. Also, network 102 may support, an Internet network, a wireless communication network, a cellular network, or the like, or any combination thereof. Network 102 may further include one, or any number of the exemplary types of networks mentioned above operating as a stand-alone network or in cooperation with each other. Network 102 may utilize one or more protocols of one or more network elements to which it is communicatively coupled. Network 102 may translate to or from other protocols to one or more protocols of network devices. Although network 102 is depicted as one network, it should be appreciated that according to one or more embodiments, network 102 may comprise a plurality of interconnected networks, such as, for example, a service provider network, the Internet, a broadcaster's network, a cable television network, corporate networks, and home networks.

Network elements 104, 106, 110, 112, 114, and data storage 108 may transmit and receive data to and from network 102 representing broadcast content, user request content, parallel search queries, parallel search responses, and other data. The data may be transmitted and received utilizing a standard telecommunications protocol or a standard networking protocol. For example, one embodiment may utilize Session Initiation Protocol (“SIP”). In other embodiments, the data may be transmitted and/or received utilizing other Voice Over IP (“VOIP”) or messaging protocols. For example, data may also be transmitted and/or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, or other protocols and systems suitable for transmitting and receiving broadcast or parallel search data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. Network 102 may use standard wireless protocols including IEEE 802.11a, 802.11b and 802.11g. Network 102 may also use protocols for a wired connection, such as an WEE Ethernet 802.3.

Transmitter/receiver 124 may be a repeater, a microwave antenna, a cellular tower, or another network access device capable of providing connectivity between to different network mediums. Transmitter/receiver 124 may be capable of sending or receiving signals via a mobile network, a paging network, a cellular network, a satellite network or a radio network. Transmitter/receiver 124 may provide connectivity to one or more wired networks and may be capable of receiving signals on one medium such as a wired network and transmitting the received signals on a second medium such as a wireless network.

Wireless device 126 may be a wireline phone, a cellular phone, a mobile phone, a satellite phone, a Personal Digital Assistants (“PDA”), a computer, a handheld MP3 player, a handheld video player, a personal media player, a gaming devices, or other devices capable of communicating with network 102 via transmitter/receiver 124.

Network elements, transmitter/receiver 124, data storage 108, and set-top box 118 may include one or more processors (not shown) for recording, transmitting, receiving, and storing data. Although network elements, transmitter/receiver 124 and data storage 108 are depicted as individual elements, it should be appreciated that the contents of one or more of a network element, transmitter/receiver 124, and data storage 108 may be combined into fewer or greater numbers of devices and may be connected to additional devices not depicted in FIG. 1. Furthermore, the one or more devices may be local, remote, or a combination thereof a first network elements, transmitter/receiver 124, and data storage 108.

Data storage 108 may be network accessible storage and may be local, remote, or a combination thereof to network elements 104, 106, 110, and 112. Data storage 108 may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, Data storage 108 may be a database, such as an Oracle database, a Microsoft SQL Server database, a DB2 database, a MySQL database, a Sybase database, an object oriented database, a hierarchical database, or other database. Data storage 108 may utilize flat file structures for storage of data.

Data storage 108 may store metadata associated with media. Metadata may include, for example, one or more of electronic program guide data, closed captioning, a digital TV subchannel, and a media metadata database. A media metadata database may include programming metadata associated with one or more forms of media such as information about television broadcasts. Metadata may also include other information such as metadata related to advertising associated with a media selection. Data storage 108 may store preferences such as search preferences, contact preferences, format preferences, subject preferences, budgets, demographic information, age related content filtering, rating related content filtering, hobbies, sports related interests, career related interests, geographic related search preferences, or other search preferences. Preferences may be stored by or associated with one or more of a user, a broadcaster, a service provider, a group, a demographic category, or another association or indexing arrangement.

According to some embodiments, data storage 108 may store one or more of identified keywords, search criteria, and search results associated with media content such as television programming. The search criteria may be used to generate search results for a plurality of users who have selected the same media (e.g., the search criteria or search results may be shared across a plurality of users watching the same television program). Search results may be shared at different times which may enable metadata to be analyzed once and single set of search results to be provided at different times to users watching programs broadcast at different times on different channels. Additionally, the storage of search results may enable the reuse of search results for users who have time shifted media content, such as for example, stored a program on a personal video recorder. In some embodiments, only search criteria may be stored which may enable modification of the criteria for individualized results for users.

Network elements 104, 106, 110, and 112 may be one or more servers (or server-like devices), such as a Session Initiation Protocol (“SIP”) server. Network elements 104, 106, 110, and 112 may include one or more processors (not shown) for recording, transmitting, receiving, and or storing data. According to one or more embodiments, network elements 104, 106, 110, and 112 may be servers providing media content to one or more users. Network elements 104, 106, 110, and 112 may be servers of a service provider, the Internet, a broadcaster, a cable television network, or another media provider.

According to one or more embodiments, network elements 104, 106, 110, and 112 may store, access, or process metadata. For example, one or more of network elements 104, 106, 110, and 112 may store, access, or process metadata associated with one or more of an Internet movie database, an online critic, an electronic program guide, closed captioning, and a server side Digital Video Recorder (“DVR”). Metadata may be stored in one or more of storage local to network elements 104, 106, 110, and 112, in data storage 108, in Customer Premises Equipment (“CPE”), in set top boxes, in residential gateways, or in other storage.

According to one or more embodiments, network elements 104, 106, 110, and 112 may store, receive, and process preferences. Preferences may be stored in one or more of storage local to network elements 104, 106, 110, and 112, in data storage 108, in Customer Premises Equipment (“CPE”), in set top boxes, in residential gateways, or in other storage.

Network elements 104, 106, 110, and 112 may provide Application Programming Interfaces (“APIs”), interface tables, Remote Procedure Calls (“RPCs”), web services, Extensible Markup Language (“XML”) based interfaces, Simple Object Access Protocol (“SOAP”) based interfaces, Common Object Request Broker Architecture (“CORBA”) and other interfaces for sending or receiving media searches, preferences or other information. Network elements 104, 106, 110, and 112 may receive data from broadcasters, users, service providers, internet information sources, or other media related information sources.

In one or more embodiments, network elements 104, 106, 110, and 112 may query one or more external sources of information to gather media associated information or facilitate media associated searches, For example, network elements 104, 106, 110, and 112 may gather information from a search engine or from a user specified web site. Additionally, network elements 104, 106, 110, and 112 may access other sources of information, such as a broadcasters data store, a media production company data store, a media distribution company data store, or other data stores.

According to one or more embodiments, network element 114 may be a residential gateway, such as a router, an optical network terminal or another piece of Customer Premises Equipment (“CPE”) providing access to one or more pieces of equipment. For example, network element 114 may provide audio/video programming content feeds to a set-top box, such as set-top box 120. Network element 114 may also provide network connectivity for other clients such as a Voice Over IP (“VOIP”) phone (not shown) and a network client, such as network client 116.

Network client 116 may be a desktop computer, a laptop computer, a server, a personal digital assistant, or other computer capable of sending and receiving network signals. Network client 116 may use a wired or wireless connection. Although depicted as connected via a residential gateway in FIG. 1, in one or more embodiments, network client 116 may connect directly to network 102 or via other network connectivity devices. According to one or more embodiments, network client 116 using a wireless connection may authenticate with a network using Wired Equivalent Privacy, Wi-Fi Protected Access or other wireless network security standards.

According to one or more embodiments, set-top box 118 receive a media selection, such as a channel selection from a user of wireless remote 122. Set-top box 118 may provide the programming feed corresponding to the selected media channel. According to some embodiments, set-top box 118 may analyze metadata to identify search criteria related to the media selection. The metadata may be local to set-top box 118 or remote from set-top box 118. For example, set-top box 118 may analyze closed captioning data associated with the selected programming feed, electronic program guide information associated with the programming feed, or other metadata. Set-top box 118 may request, query, or otherwise interface with remote sources of data. According to some embodiments, set-top box 118 may forward selection data to one or more network components, such as one or more of network elements 104, 106, 110, and 112. Set-top box 118 may also forward metadata associated with a media selection to one or more network elements, such as network elements 104, 106, 110, and 112. According to some embodiments, set-top box 118 may forward only a channel selection and one or more network elements may separately obtain metadata.

In one or more embodiments, set-top box 118 may analyze metadata to identify search criteria, such as a keyword, a program name, a program subject, a program category, a channel category, a subject of an advertisement, a topic, a product, a service, a category, a genre, a director, an actor, a rating, a date, programming start markers, programming stop markers, a current time in a user time zone, or other broadcast information useful for focusing a search for material related to a media selection. According to one or more embodiments, other network accessible elements such as one of network elements 104, 106, 110, and 112 may analyze metadata. In some embodiments, analysis of metadata may be distributed across two or more of set-top box 118, network elements 104, 106, 110, and 112, and other network accessible systems.

Search criteria identified from metadata, such as keywords, may be used in inputs in searches against one or more systems. Searches may be constructed and limited by preferences, such as user preferences, service provider preferences or other preferences. In some embodiments, a partner or preferred service may be used for searches. For example, search inputs may be used in searches for a preferred online retailer. Search results may include products related to selected programming, such as one or more of: apparel with logos associated with the programming, ingredients available for a recipe of a cooking show, music, CDs, or DVDs associated with an artist featured on selected programming, materials to build a project featured on selected programming, travel related information for destinations featured in selected programming, contact information for an individual or organization featured in selected programming, and other related goods or services. Search results may include one or more of: links to online references associated with selected programming, bibliographic information for related references associated with selected programming, contact information for experts in a topic associated with selected programming, reviews associated with selected programming, ratings associated with a product or service, and statistics associated with one or more subjects of selected programming (e.g., sports statistics associated with a team; demographic statistics associated with a city in a travel or home show; and polls associated with a political issue). Informational searches may be performed against public systems, such as free Internet based sources, or private systems, such as, subscription based services (e.g., a product review service or a specialized reference), or other systems.

According to one or more embodiments, results may be processed by one or more network accessible devices, such as, network elements 104, 106, 110, and 112. Search results processing may include filtering based on one or more criteria such as: preferences, including user preferences, broadcaster preferences, service provider preferences, a user profile, and user demographics. For example, search results may be filtered by one or more user specified preferences to include only search results on specified topics, specified programming, with certain ratings, or based on other factors. User specified preferences may be input by a user through one or more interfaces. According to some embodiments, a user website may allow a user to specify search preferences, provide demographic information, provide preferred formatting options (e.g., HTML only, text only), delivery options (e.g., email, blog, text message, voicemail, etc.), a maximum number of search results returned, a size limit on search results to be returned, or other options. For example, search results may include formatting as XML (“eXtensible Markup Language”) and providing as an RSS (“Really Simple Syndication”) feed. Search results may be summarized or sampled in a message to a user and link to full search contents on a website may be provided in the message.

The various components of system 100 as shown in FIG. 1 may be further duplicated, combined and/or integrated to support various applications and platforms. Additional elements may also be implemented in the systems described above to support various applications.

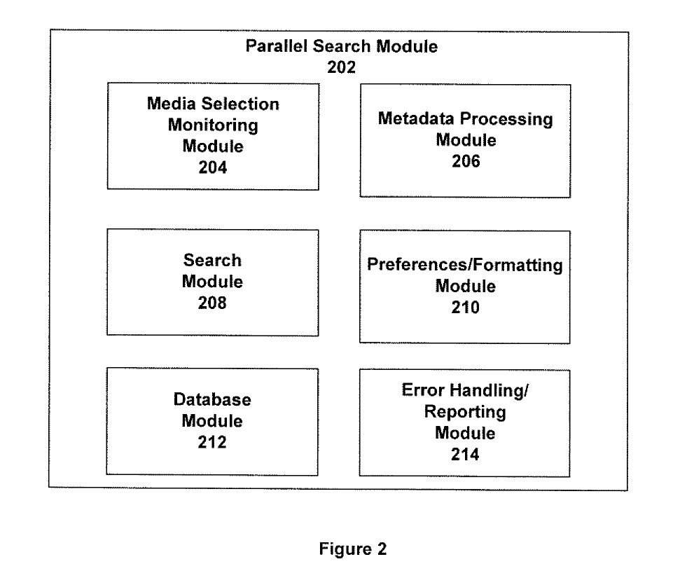

FIG. 2 is a block diagram of a hardware component of the system for parallel searching according to a particular embodiment. Referring to FIG. 2, there is shown a parallel search module 202 for providing parallel searching in accordance with an embodiment of the present disclosure. As illustrated, the parallel search module 202 may contain one or more components including media selection monitoring module 204, metadata processing module 206, search module 208, preferences/formatting module 210, database module 212, and error handling/reporting module 214. Although parallel search module 202 is depicted as a single module, functionality or modules of parallel search module 202 may be located on a single device or distributed across a plurality of devices including one or more centralized servers and one or more pieces of customer premises equipment or end user devices.

Media selection monitoring module 204 may monitor user input, such as media selection. Media selection may be used at least in part to determine relevant search inputs to provide search results presented in parallel to a user's viewing of media. User inputs may be a channel selection, a program selection, or other input. According to one or more embodiments, media selection monitoring module may be a process or component of a user device, such as a set-top box.

Metadata processing module 206 may perform one or more of retrieving, storing, processing, and analyzing metadata. Metadata may be organized in a manner that enables searching or analyzing metadata based on associated media. For example, closed captioning may be associated as in-band information of a program feed. As another example, an electronic program guide may be organized by channel, network, and/or timeslot. Metadata may be analyzed to identify keywords, topics, categories, demographics, or other search input. Metadata may be analyzed by a broadcaster or service provider network element, Customer Premises Equipment (“CPE”), an public network accessible resource (e.g. an Internet accessible metadata data store, such as the Internet Movie Database). Metadata may be stored on one or more forms of electronic storage, such as a file server or a database which may be accessed or managed by database module 212. In one or more embodiments, metadata may not be stored but may be sampled, scanned, or analyzed while provided as part of a media feed to a user.

Search module 208 may receive input or other search criteria from metadata processing module 206. Search module 208 may interface with preferences/formatting module 210 to receive search preferences, a search profile, search constraints or other data. Search module 208 may search one or more electronic references to generate search results. Search module 208 may receive search criteria or other input from metadata processing module 206 after a media selection of a user is detected by media selection monitoring module 204. According to one or more embodiments, this may enable the return of one or more search results while the user is still receiving the selected media. For example, according to one embodiment, search results related to a television show may be sent as a message to a user's cell phone while the user is still watching the show. In another example, product ordering information may be presented to a user during or shortly after a commercial Search results may include, for example, one or more of product information associated with an electronic media selection, service information associated with an electronic media selection, a website associated with an electronic media selection, an online reference associated with an electronic media selection, and contact information associated with an electronic media selection. Search module 208 may provide one or more search results to preferences/formatting module 210 for formatting prior to presentation or delivery of the results.

Preferences/formatting module 210 may store preferences associated with searching, such as search preferences, contact preferences, format preferences, subject preferences, budgets, demographic information, age related content filtering, rating related content filtering, hobbies, sports related interests, career related interests, geographic related search preferences, or other search preferences. Preferences may be stored by or associated with one or more of a user, a broadcaster, a service provider, a group, a demographic category, or another association or indexing arrangement. Preferences/formatting module 210 may format one or more search results. Preferences/formatting module 210 may provide a user interface enabling a user to set search preferences, search result delivery preferences, search result formatting preferences, or other preferences. For example, a user may specify topics or keywords of interest, select programming of interest, provide contact information (e.g., email addresses, phone numbers, and online messaging IDs), set limits on a maximum amount or size of search results, or provide other search and result related parameters. Preferences/formatting module 210 may provide a website as a user interface, a voice response unit as a user interface, or other user interfaces. In one or more embodiments, preferences/formatting module 210 may post search results to a website that may require a user login or user authentication. Preferences/formatting module 210 may also process preferences set by an administrator, a group, a service provider, or other entity. For example, a service provider may provide a filter that may prevent offensive material, viruses, or malware from being presented as a search result.

Preferences/formatting module 210 may further process search results such as, for example, filtering or formatting search results. Formatting may include putting the search results into a format compatible with one or more user devices. For example, search results may be formatted as eXtensible Markup Language (“XML”) and provided to a user as a Really Simple Syndication (“RSS”) feed. Preferences/formatting module 210 may deliver one or more search results according to specified preferences. Search results may be sent to an email address, a website associated with a user, a text message, a voicemail, or other electronically accessible destinations. According to some embodiments, one or more search results may be faxed or mailed to a user.

Database module 212 may manage or access electronic storage including databases and other organized electronic storage. Database module 212 may provide one or more interfaces for search module 208. Database module 212 may store metadata, such as, electronic program guide information, closed captioning information, programming reviews, programming summaries, and other media metadata. Database module 212 may store or access preferences.

Error handling/reporting module 214 may handle one or more errors associated with analyzing metadata, searching, and providing user results. Error handling/reporting module 214 may provide alerts or messages to administrators in the event of an error. Error handling/reporting module 214 may track responses to search results. For example, according to one or more embodiments posted links in a results web page that are clicked on may be detected and may be used to gauge a user's interest for the purposes of providing future results. Error handling/reporting module 214 may produce one or more reports including error reports, usage reports, and user activity reports.

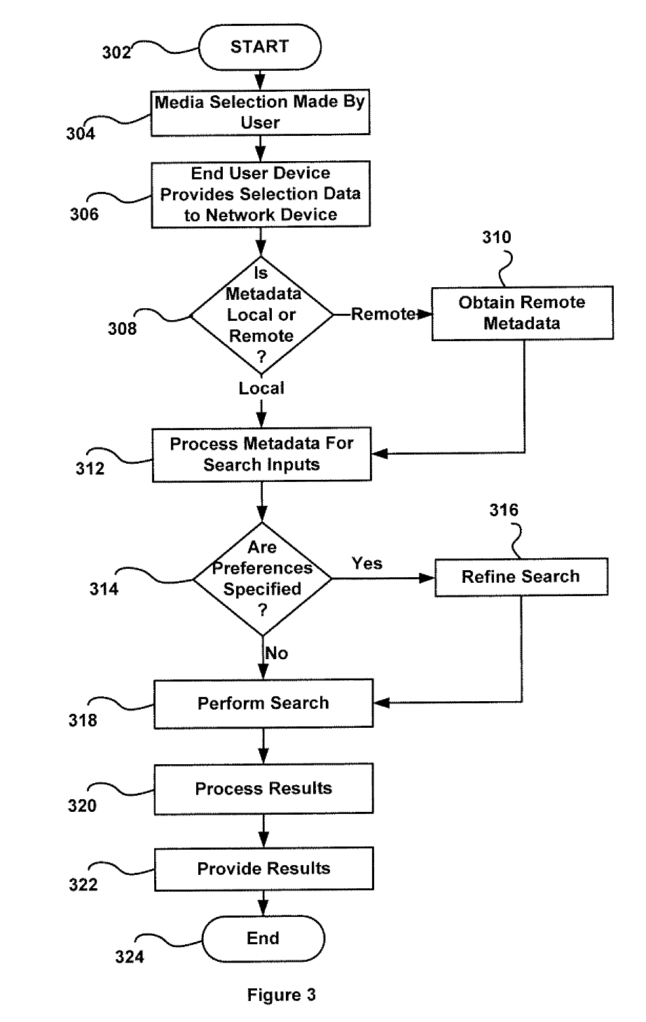

FIG. 3 is a flowchart illustrating the functionality for parallel searching of a particular embodiment. At block 302, the method 300 for parallel searching may begin. At block 304, a media selection may be made by a user. For example, a user may choose a channel, select programming to be webcast, or choose programming from a personal video recorder menu.

At block 306, an end user device, such as a set-top box, a personal computer, a personal video recorder, or other media playback device may provide data regarding a user's media selection to one or more network devices. The data may include a channel selection, a local time, or other media identifiers. The network devices may be additional equipment a user site, a separate component of a user device (e.g., a separate component of a set-top box), or one or more pieces of remote equipment. For example, the selection data may be provider to a server at a service provider location.

At block 308, the method may determine whether metadata should be obtained, accessed, or retrieved from a local or remote source. If the metadata is to be obtained from a remote source, the method may continue at block 310. If the metadata is to be obtained from a local source, the method may continue at block 312.

At block 310, metadata may be obtained from a remote source such as, for example, a server, database, or other data store containing media related metadata. For example, a server providing an electronic program guide, closed captioning, or media reviews may be used.

At block 312, metadata may be processed for search results. If local metadata is to be used, an end user device, such as a set-top box, may provide the metadata to a central server. In one or more embodiments, the metadata may be analyzed by an end user device and search inputs such as, for example, keywords, may be identified by the end user device. The search inputs may then be provided to one or more network accessible devices to perform a search. According to some embodiments, metadata may be obtained by an end user device and sent to a central server or other network accessible devices. The central server may then analyze the metadata to identify keywords. In one or more embodiments, a central server may store keywords or other search input associated with selected media and may use the search inputs to generate search results for a plurality of users at different locations who selected the same media.

At block 314, the method 300 may determine whether preferences have been specified for searching. If preferences have been specified, the method may continue at block 316. If no preferences have been specified the method may continue at block 318.

At block 316, search criteria may be refined based on specified preferences. According to some embodiments, a user may specify interests, keywords, demographic information, or other information which may be used to refine a search. According to some embodiments, a user may opt-out of one or more searches. For example, a user may specify that they do not wish to receive search results associated with one or more categories or topics, such as products or services associated with advertisements played during programming.

At block 318, the method 300 may perform a search to identify resources and information associated with a users media selection. For example, if a user is watching a sports event, search results may provide ticket information, links to websites for ordering tickets, team statistics, player statistics, and websites or stores that offer team merchandise. In another example, if a media selection is a program involving a project (e.g., a home show, a cooking show, a craft show), search results may include contact information for merchants offering supplies for the project, services that provide the project (e.g., carpenters, caterers, etc,), information sources related to the project, or other project related resources.

At block 320, the search results may be processed. Processing may include filtering based on one or more specified preferences, ranking according to relevance, and formatting. Formatting may differ based on a target destination for search results (e.g., email, text message, website, voicemail). Formatting may also be based at least in part on user specified preferences. Filtering may also scan for malware, offensive content, or results exceeding a specified size.

At block 322, results may be provided to a user via one or more end user devices and in one or more formats. For example, a user watching television (via broadcast, cable, personal video recorder, streaming from network, etc.) may receive a text message on their cell phone with results. The text message may include one or more of: the results; a link to the results; information that the results have been posted to a webpage; and other information.

At block 324, the method 300 may end.

The description above describes one or more devices including user devices, a communication network having network elements that are coupled to each other via one or more links (e.g., physical or logical), a communication network, and other elements for coupling customers to the communication network, some of which are explicitly depicted, others of which are not. As used herein, the term “module” may be understood to refer to executable software, firmware, hardware, or various combinations thereof. It is noted that the modules are exemplary. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, etc.) separately. The functions described as being performed at various components may be performed at other components, and the various components may be combined or separated. Other modifications also may be made.

In the preceding specification, various preferred embodiments have been described with references to the accompanying drawings. It will, however, be evident that various modifications and chances may be made thereto, and additional embodiments may be implemented, without departing from the broader scope of invention as set forth in the claims that follow. The specification and drawings are accordingly to be regarded in an illustrative rather than restrictive sense.

We claim:

1. A method, comprising:
receiving, at a network device, an indication of an electronic media selection from a user;
identifying a search input in metadata associated with the electronic media selection;
searching one or more electronic data sources based at least in part on the identified search input; and
providing one or more search results via a network to one or more devices accessible to the user, wherein the one or more search results are capable of being delivered during delivery of the electronic media selection to the user.

2. The method of claim 1, wherein the electronic media selection comprises a television programming selection.

3. The method of claim 2, wherein the metadata comprises at least one of: electronic program guide data, closed captioning, a digital TV subchannel, and a programming metadata database.

4. The method of claim 1, wherein the search input comprises at least one of: a keyword, a program name, a program subject, a program category, a channel category, and a subject of an advertisement.

5. The method of claim 1, wherein the electronic media selection comprises at least one of: personal video recording, streaming media, webcasting, and broadcasting.

6. The method of claim 1, wherein the searching is based at least in part on one or more specified preferences.

7. The method of claim 6, wherein the specified preferences comprise at least one of: user preferences, a user profile, demographics associated with a user, demographics associated with a household, and service provider preferences.

8. The method of claim 1, wherein the search results comprise at least one of: product information associated with an electronic media selection, service information associated with an electronic media selection, a website associated with an electronic media selection, an online reference associated with an electronic media selection, and contact information associated with an electronic media selection.

9. The method of claim 1, further comprising formatting one or more search results.

10. The method of claim 9, wherein the one or more search results are formatted as at least one of: a Really Simple Syndication (“RSS”) feed, a web page, a text message, a blog post, and a voicemail.

11. A computer readable media comprising code to perform the acts of the method of claim 1.

12. A system, comprising:
a network element communicatively coupled to a network wherein the network element comprises one or more processors configured to:
receive an indication of an electronic media selection from a user;
identify a search input in metadata associated with the electronic media selection;
search one or more data sources based at least in part on the identified search input; and
provide one or more search results via the network to one or more devices accessible to a user, wherein the one or more search results are capable of being delivered during delivery of the electronic media selection to the user.

13. The system of claim 12, wherein the media selection comprises a television programming selection.

14. The system of claim 12, wherein the metadata comprises at least one of: electronic program guide data, closed captioning, a digital TV subchannel, and a programming metadata database.

15. The system of claim 12, wherein the search input comprises at least one of: a keyword, a program name, a program subject, a program category, a channel category, and a subject of an advertisement.

16. The system of claim 12, wherein the media selection comprises at least one of: personal video recording, streaming media, webcasting, and broadcasting.

17. The system of claim 12, wherein the searching is based at least in part on one or more specified preferences.

18. The system of claim 12, wherein the specified preferences comprise at least one of: user preferences, a user profile, demographics associated with a user, demographics associated with a household, and service provider preferences.

19. The system of claim 12, wherein the search results comprise at least one of: product information associated with the electronic media selection, service information associated with the electronic media selection, a website associated with the electronic media selection, an online reference associated with the electronic media selection, and contact information associated with the electronic media selection.

20. The system of claim 12, wherein the one or more processors are further configured to format the one or more search results.

21. The system of claim 20, wherein the one or more search results are formatted as at least one of: a Really Simple Syndication (“RSS”) feed, a web page, a text message, a blog post, and a voicemail.
